(19) United States
(12) Patent Application Publication
(10) Pub. No.: US 2026/0032487 A1
(43) Pub. Date: Jan. 29, 2026

(54) COMMUNICATION METHOD AND APPARATUS, DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/996,911

(22) PCT Filed: Jul. 21, 2022
(86) PCT No.: PCT/CN2022/107208

§ 371 Date: Jan. 17, 2025

(51) Int. Cl. H04W 24/10; H04W 12/08; H04W 56/00

(52) U.S. Cl. CPC H04W 24/10; H04W 12/08; H04W 56/0015

(57) ABSTRACT

A method for wireless communication performed by a station (STA), includes: determining a first message frame, wherein the first message frame comprises first indication information, the first indication information indicates one or more sensing measurement modes supported by the STA, and the STA has not established an initial association link with an access point (AP) for communications; and transmitting the first message frame.

### CROSS-REFERENCE TO RELATED APPLICATION

This application is the U.S. national phase application of International Application No. PCT/CN2022/107208, filed on Jul. 21, 2022, the disclosure of which is incorporated herein by reference in its entirety for all purposes.

### TECHNICAL FIELD

Examples of the present disclosure relate to the field of communication technologies. Particularly, the examples of the present disclosure relate to a communication method, apparatus, device, and storage medium.

### BACKGROUND

With the rapid development of mobile communication technologies, wireless fidelity (Wi-Fi) technologies have made great progress in terms of transmission rate and throughput. For the Wi-Fi technologies currently being studied, wireless local area network (WLAN) sensing technologies may be supported, e.g. in application scenarios such as location discovery, proximity detection and presence detection in a dense environment (such as a home environment or a company environment).

A station (STA) may serve as a sensing measurement initiator or a sensing measurement responder. For the STA that has not established an initial association link with an access point (AP) for communications, it may determine a sensing measurement mode of the AP via a related message frame broadcasted by the AP, and then establish a corresponding sensing measurement. However, it is currently uncertain on how the AP determines one or more sensing measurement modes supported by the STA that is to establish the initial association link with the AP.

### SUMMARY

Examples of the present disclosure provide a communication method, apparatus, device, and storage medium, which can provide a scheme for a station (STA) that has not established an initial association link with an access point (AP) for communications to indicate one or more sensing measurement modes supported by the STA.

In a first aspect, the examples of the present disclosure provide a communication method, performed by an STA, and the method includes: determining a first message frame, wherein the first message frame includes first indication information, the first indication information indicates one or more sensing measurement modes supported by the STA, and the STA has not established an initial association link with an AP for communications; and transmitting the first message frame.

In a second aspect, the examples of the present disclosure provide a communication method, performed by an AP, and the method includes: receiving a first message frame, wherein the first message frame includes first indication information, the first indication information indicates one or more sensing measurement modes supported by an STA, and the STA has not established an initial association link with the AP for communications.

In a third aspect, the examples of the present disclosure further provide an STA, including one or more memories, one or more processors, and a computer program stored in the one or more memories and executable on the one or more processors. The program, when executed by the one or more processors, is configured to: determine a first message frame, wherein the first message frame includes first indication information, the first indication information indicates one or more sensing measurement modes supported by the STA, and the STA has not established an initial association link with an AP for communications; and transmit the first message frame.

In the examples of the present disclosure, for the STA that has not established the initial association link with the AP for communications, it may transmit the first message frame to the AP to indicate the one or more sensing measurement modes supported by it via the first indication information in the first message frame.

For the additional aspects and advantages of the present disclosure, a part of them will be set forth in the following description, which will be apparent according to the following description or be learned through putting the present disclosure into practice.

### BRIEF DESCRIPTION OF THE DRAWINGS

The drawings to be used in the description of the examples of the present disclosure will be briefly introduced to explain the technical solutions provided by examples of the present disclosure more clearly. It is evident that, the drawings in the following description illustrate only some examples of the present disclosure, and based on these drawings, those of ordinary skill in the art may obtain other drawings without creative work.

FIG. 1 is a schematic architectural diagram of a WLAN sensing measurement provided in an example of the present disclosure.

FIG. 2 is a schematic diagram of communication links provided in an example of the present disclosure.

FIG. 3 is another schematic architectural diagram of a WLAN sensing measurement provided in an example of the present disclosure.

FIG. 4 is a schematic flowchart of communication methods provided in an example of the present disclosure.

FIG. 5 is another schematic flowchart of communication methods provided in an example of the present disclosure.

FIG. 6 is a schematic timing diagram of communication methods provided in an example of the present disclosure.

FIG. 7 is another schematic timing diagram of communication methods provided in an example of the present disclosure.

FIG. 8 is a schematic structural diagram of communication apparatuses provided in an example of the present disclosure.

FIG. 9 is another schematic structural diagram of communication apparatuses provided in an example of the present disclosure.

FIG. 10 is a schematic structural diagram of an electronic device provided in an example of the present disclosure.

### DETAILED DESCRIPTION OF THE EMBODIMENTS

The term “and/or” in examples of the present disclosure describes association relationships between associated objects, indicating that there may be three types of relationships. For example, A and/or B means that A exists alone, A and B exist at the same time, and B exists alone. The character “/” generally indicates that the associated objects before and after are in an “or” relationship.

The term “multiple” in the examples of the present disclosure refers to two or more than two, and other quantifiers are similar thereto.

The examples will be described in detail herein, whose instances are illustrated in the accompanying drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a,” “said” and “the” in their singular forms in the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be used in the present disclosure to describe various information, such information should not be limited to these terms. These terms are only used to distinguish the information of the same type with each other. For example, without departing from the scope of the present disclosure, first information may be referred to as second information; and similarly, second information may also be referred to as first information. Depending on the context, the word “if” as used herein may be interpreted as “when,” “upon,” or “in response to determining.”

The following, in conjunction with the drawings of the examples of the present disclosure, will clearly and completely describe the technical solutions provided in the examples of the present disclosure. It is evident that the described examples are a part, but not all, of the examples of the present disclosure. Based on the examples provided in the present disclosure, all of other examples, which can be obtained by those of ordinary skill in the art without creative work, shall fall within the protection scope of the present disclosure.

The methods and the apparatuses are based on the same disclosed concept. For the methods and the apparatuses, their implementations can refer to each other since their principles of solving problems are similar, and their repeated parts are not to be repeated.

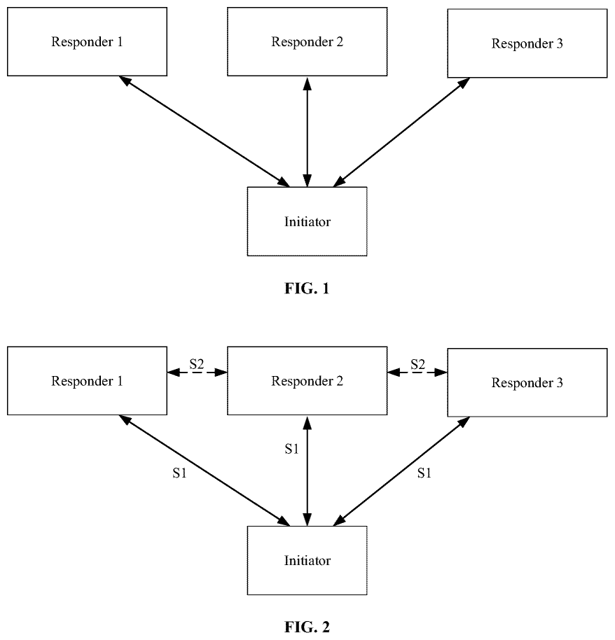

As a first example, referring to FIG. 1 to FIG. 3, wireless local area network (WLAN) sensing measurement architectures and WLAN sensing measurement procedures to which communication methods provided in the examples of the present disclosure are first introduced.

FIG. 1 illustrates a schematic architectural diagram of a WLAN sensing measurement. A sensing initiator initiates a WLAN sensing measurement (e.g., initiates a WLAN sensing measurement session). There may be a plurality of sensing responders responding thereto, such as Responder 1, Responder 2, and Responder 3 as illustrated in FIG. 1. When the sensing initiator initiates the WLAN sensing measurement, the plurality of associated or unassociated sensing responders for the WLAN sensing measurement may perform the response.

Being “associated” here may refer to that an initial association link for communications has been established between the sensing initiator and the sensing responder, and being “unassociated” may refer to that no initial association link for communications has been established between the sensing initiator and the sensing responder.

Referring to FIG. 2, the sensing initiator communicates with the sensing responders via communication links, as illustrated by communication links S1, and the sensing responders communicate with each other via communication links S2.

Each sensing initiator may be a client, and each sensing responder (i.e., sensing responder 1 to sensing responder 3 in the example) may be a station (STA) or an access point (AP).

The AP is a wireless switch used in a wireless network and is also an access device for the wireless network. The AP may include software applications and/or circuits to enable other types of nodes in the wireless network to communicate externally and internally to the wireless network through the AP. For example, the AP may be a terminal device or a network device equipped with a wireless fidelity (Wi-Fi) chip.

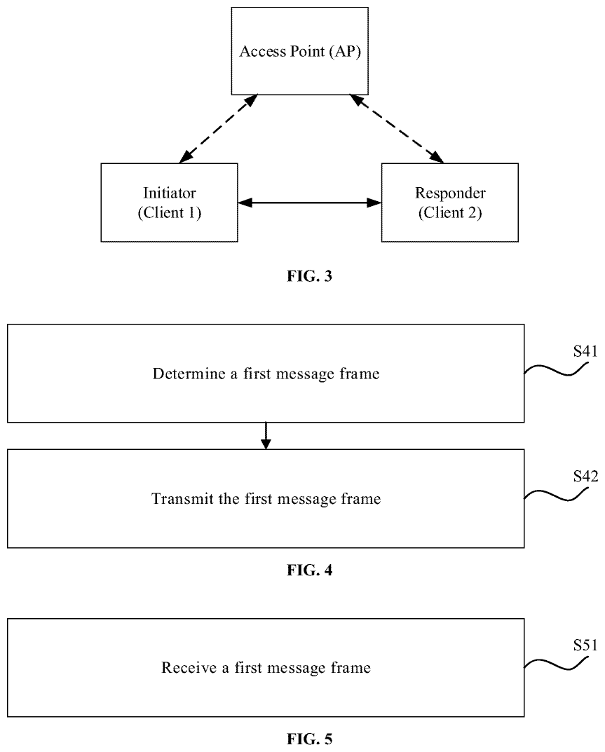

As another architecture, as illustrated in FIG. 3, the sensing initiator and the sensing responder may be both clients, and the two may communicate by connecting to the same AP. In FIG. 3, Client 1 is the sensing initiator, and Client 2 is the sensing responder.

A communication method provided in an example of the present disclosure may specifically refer to FIG. 4, which is a schematic flowchart of the communication methods provided in the examples of the present disclosure. Alternatively, or additionally, the method is applicable to an STA. The method may include the following steps.

At step S41, a first message frame is determined.

The first message frame includes the first indication information. The first indication information indicates one or more sensing measurement modes supported by the STA.

The one or more sensing measurement modes supported by the STA may also be regarded as basic capability information of the STA supporting a sensing measurement.

The STA has not established an initial association link (i.e., an initial link setup) with an AP for communications.

The one or more sensing measurement modes supported by the STA include at least one of the following: a trigger-based (TB) measurement, a responder-to-responder (R2R) measurement, a non-trigger-based (Non-TB) measurement, or a sensing by proxy (SBP) measurement.

At step S42, the first message frame is transmitted.

As an example, for the STA that has not established the initial association link with the AP for communications, it may transmit the first message frame to the AP to indicate the one or more sensing measurement modes supported by the STA via the first indication information included in the first message frame.

In the communication method applied to the STA provided in the present disclosure, the one or more sensing measurement modes supported by the STA include at least one of: the TB measurement or the R2R measurement.

The R2R measurement means that the AP triggers an entire sensing measurement procedure, one STA serves as a transmitter (i.e., a sensing transmitter) of a null data packet (NDP) frame, and the other STAs serve as receivers (i.e., sensing receivers) of the NDP frame and perform the sensing measurement after receiving the NDP frame. Meanwhile, when the STA serves as the transmitter of the NDP frame, the AP may also receive the NDP frame and perform the sensing measurement.

As an example, the STA that has not established the initial association link with the AP may transmit the first message frame to the AP, and indicate at least one of: the TB measurement or the R2R measurement supported by it via the first indication information included in the first message frame.

In the communication method applied to the STA provided in the present disclosure, the first message frame transmitted by the STA that has not established the initial association link with the AP is at least one of: a sensing measurement setup request frame, a sensing measurement setup query frame, or a sensing measurement setup notification frame.

In a possible implementation, the STA transmits the one or more sensing measurement modes supported by the STA before transmitting the sensing measurement setup request frame. The one or more sensing measurement modes supported by the STA include at least one of the following: the TB measurement, the R2R measurement, the Non-TB measurement, or the SBP measurement. That is, the STA may transmit the one or more sensing measurement modes supported by the STA before transmitting the sensing measurement setup request frame.

In another possible implementation, the STA may transmit the one or more sensing measurement modes supported by the STA via the sensing measurement setup request frame. The one or more sensing measurement modes supported by the STA include at least one of the following: the TB measurement, the R2R measurement, the Non-TB measurement, or the SBP measurement. That is, the STA may indicate other sensing measurement modes supported by the STA while transmitting the sensing measurement setup request frame that may be configured to request a setup of one sensing measurement mode supported by the STA. For example, the first indication information may indicate all the sensing measurement modes supported by the STA. For example, the first indication information may indicate the other sensing measurement modes supported by the STA, and the other sensing measurement modes do not include the sensing measurement mode whose setup is required by the sensing measurement setup request frame. In an illustrative example, it is assumed that the STA supports the TB measurement, the R2R measurement, the Non-TB measurement and the SBP measurement, and the Non-TB measurement is to be established between the AP and the STA via the sensing measurement setup request frame. In this case, the sensing measurement setup request frame also includes the first indication information. The first indication information indicates all the sensing measurement modes supported by the STA (the TB measurement, the R2R measurement, the Non-TB measurement, and the SBP measurement). Alternatively, the first indication information indicates the other sensing measurement modes supported by the STA, and the other sensing measurement modes do not include the sensing measurement mode whose setup is required by the sensing measurement setup request frame (the TB measurement, the R2R measurement and the SBP measurement are included, and the Non-TB measurement is not included since the Non-TB measurement is the sensing measurement mode whose setup is required by the sensing measurement setup request frame).

In another possible implementation, the STA may transmit the first indication information via the sensing measurement setup query frame or the sensing measurement setup notification frame after transmitting the sensing measurement setup request frame. The first indication information indicates that the STA supports at least one of the following sensing measurement modes: the TB measurement, the R2R measurement, the Non-TB measurement, or the SBP measurement. For example, the first indication information may indicate all the sensing measurement modes supported by the STA. For example, the first indication information may indicate the other sensing measurement modes supported by the STA, and the other sensing measurement modes do not include the sensing measurement mode whose setup is required by the sensing measurement setup request frame. In an illustrative example, it is assumed that the STA supports the TB measurement, the R2R measurement, the Non-TB measurement and the SBP measurement, and the Non-TB measurement is to be established between the STA and the AP via the sensing measurement setup request frame. In this case, the first indication information is transmitted via the sensing measurement setup query frame or the sensing measurement setup notification frame that includes the first indication information. The first indication information indicates all the sensing measurement modes supported by the STA (the TB measurement, the R2R measurement, the Non-TB measurement, and the SBP measurement). Alternatively, the first indication information indicates the other sensing measurement modes supported by the STA. The other sensing measurement modes are the sensing measurement modes that exclude the sensing measurement mode whose setup is required by the sensing measurement setup request frame (which include the TB measurement, the R2R measurement and the SBP measurement but exclude the Non-TB measurement since the Non-TB measurement is the sensing measurement mode whose setup is required by the sensing measurement setup request frame).

As an example, the STA that has not established the initial association link with the AP transmits the sensing measurement setup request frame to the AP. The sensing measurement setup request frame includes the first indication information, and the first indication information indicates the one or more sensing measurement modes supported by the STA.

As an example, the STA that has not established the initial association link with the AP transmits the sensing measurement setup query frame to the AP. The sensing measurement setup query frame includes the first indication information, and the first indication information indicates the one or more sensing measurement modes supported by the STA.

As an example, the STA that has not established the initial association link with the AP transmits the sensing measurement setup notification frame to the AP. The sensing measurement setup notification frame includes the first indication information, and the first indication information indicates the one or more sensing measurement modes supported by the STA.

In a possible implementation, the one or more sensing measurement modes supported by the STA include at least one of the following: the TB measurement, the R2R measurement, the Non-TB measurement, or the SBP measurement.

In the communication method applied to the STA provided in the present disclosure, when the first message frame is the sensing measurement setup request frame, the sensing measurement setup request frame is configured to request the setup of at least one of: the Non-TB measurement or the SBP measurement.

The sensing measurement whose setup is requested by the sensing measurement setup request frame is a sensing measurement mode supported by the AP, where the STA serves as a sensing initiator of the sensing measurement whose setup is requested, and the AP serves as a sensing responder of the sensing measurement whose setup is requested.

As an example, the STA that has not established the initial association link with the AP transmits the sensing measurement setup request frame to the AP, and the sensing measurement setup request frame is configured to request the setup of at least one of: the Non-TB measurement or the SBP measurement. In one implementation, the sensing measurement setup request frame may also include the first indication information, and the first indication information indicates the one or more sensing measurement modes supported by the STA that has not established the initial association link with the AP, where the one or more sensing measurement modes may be at least one of: the TB measurement or the R2R measurement.

In the communication method applied to the STA provided in the present disclosure, when the first message frame is the sensing measurement setup query frame or the sensing measurement setup notification frame and before the STA that has not established the initial association link with the AP transmits the first message frame, it further includes: transmitting a sensing measurement setup request frame.

The sensing measurement setup request frame is configured to request the setup of at least one of: the Non-TB measurement or the SBP measurement. The sensing measurement setup query frame or the sensing measurement setup notification frame includes the first indication information that indicates the one or more supported sensing measurement modes.

That is, after transmitting the sensing measurement setup request frame to the AP, the STA that has not established the initial association link with the AP also transmits the sensing measurement setup query frame or the sensing measurement setup notification frame to the AP, and indicates the one or more sensing measurement modes supported by the STA via the first indication information in the sensing measurement setup query frame or the sensing measurement setup notification frame.

The communication method applied to the STA provided in the present disclosure also includes: receiving a second message frame. The second message frame includes second indication information, and the second indication information indicates one or more sensing measurement modes supported by the AP.

In a possible implementation, before indicating the one or more sensing measurement modes supported by the STA via the first indication information, the STA may receive the second message frame, where the second message frame indicates the one or more sensing measurement modes supported by the AP.

In another possible implementation, after indicating the one or more sensing measurement modes supported by the STA via the first indication information, the STA may receive the second message frame, where the second message frame indicates the one or more sensing measurement modes supported by the AP.

In yet another possible implementation, the STA receives the second message frame while indicating the one or more sensing measurement modes supported by the STA via the first indication information, where the second message frame indicates the one or more sensing measurement modes supported by the AP.

That is, the example of the present disclosure does not limit the slots for transmitting the first message frame and the second message frame. The first message frame and the second message frame may be transmitted in any order or at the same time, all of which are within the protection scope of the technical solutions of the present disclosure.

The one or more sensing measurement modes supported by the AP include at least one of the following: the TB measurement, the R2R measurement, the Non-TB measurement, or the SBP measurement.

As an example, the STA that has not established the initial association link with the AP receives the second message frame transmitted by the AP, where the second message frame includes the second indication information that indicates the one or more measurement modes supported by the AP. After receiving the second message frame, the STA may transmit the sensing measurement setup request frame to the AP to request the setup of a sensing measurement mode supported by both the STA and the AP, which may be the Non-TB measurement or the SBP measurement.

In the communication method applied to the STA provided in the present disclosure, the second message frame received by the STA that has not established the initial association link with the AP is at least one of: a beacon frame or a probe response frame.

As an example, the STA that has not established the initial association link with the AP receives the beacon frame transmitted by the AP, where the beacon frame includes the second indication information that indicates the one or more measurement modes supported by the AP.

As an example, the STA that has not established the initial association link with the AP receives the probe response frame transmitted by the AP, where the probe response frame includes the second indication information that indicates the one or more measurement modes supported by the AP.

The communication method applied to the STA provided in the present disclosure also includes: receiving a sensing measurement setup response frame.

The sensing measurement setup response frame includes first identifier information. The first identifier information indicates one or more sensing measurement modes in which the AP allows the STA to participate.

As an example, in a case where the first message frame is the sensing measurement setup request frame, the STA that has not established the initial association link with the AP transmits the sensing measurement setup request frame to the AP for requesting the setup of the Non-TB measurement or the SBP measurement. The sensing measurement setup request frame includes the first indication information that indicates the one or more sensing measurement modes supported by the STA. After transmitting the sensing measurement setup request frame, the STA may receive the sensing measurement setup response frame transmitted by the AP. The sensing measurement setup response frame includes the first identifier information that indicates the one or more sensing measurement modes in which the AP allows the STA to participate.

As an example, in a case where the first message frame is the sensing measurement setup query frame or the sensing measurement setup notification frame, the STA that has not established the initial association link with the AP transmits the sensing measurement setup request frame to the AP for requesting the setup of the Non-TB measurement or the SBP measurement. Further, the STA may receive the sensing measurement setup response frame transmitted by the AP. The sensing measurement setup response frame includes the first identifier information that indicates the one or more sensing measurement modes in which the AP allows the STA to participate. Then, the STA may transmit the sensing measurement setup query frame or the sensing measurement setup notification frame to the AP. The sensing measurement setup query frame or the sensing measurement setup notification frame includes the first indication information that indicates the one or more sensing measurement methods supported by the STA.

The one or more sensing measurement modes, which are indicated by the first identifier information and in which the STA is allowed to participate, include at least one of the following: the TB measurement, the R2R measurement, the Non-TB measurement, or the SBP measurement. For example, the STA may receive the sensing measurement setup response frame transmitted by the AP. The sensing measurement setup response frame includes the first identifier information, and the first identifier information indicates that the AP allows the STA to participate in the R2R measurement or the Non-TB measurement.

In the communication method applied to the STA provided in the present disclosure, the sensing measurement setup response frame, which is received by the STA that has not established the initial association link with the AP, includes at least one of: an un-association identifier (UID) or a time synchronization function (TSF) parameter assigned by the AP to the STA.

The UID is configured to identify the sensing measurement whose setup is requested by the sensing measurement setup request frame.

The TSF parameter is configured to enable the STA and the AP to maintain time synchronization during the sensing measurement procedure.

In the communication method applied to the STA provided in the present disclosure, the STA that has not established the initial association link with the AP transmits the sensing measurement setup request frame after performing a pre-association security negotiation (PASN) with the AP. That is, in a case of establishing no initial association link with the AP, the STA transmits the sensing measurement setup request frame to the AP after performing the PASN, so as to ensure a data transmission security.

In the communication method applied to the STA provided in the present disclosure, the sensing measurement setup request frame, which is transmitted by the STA that has not established the initial association link with the AP, includes a sensing measurement setup identifier for identifying the sensing measurement setup procedure.

A communication method provided in an example of the present disclosure may be specifically referred to FIG. 5, which is another schematic flowchart of the communication methods provided in the examples of the present disclosure. Alternatively, or additionally, the method may be applied to an AP. The method may include the following steps.

At step S51, a first message frame is received.

The first message frame includes first indication information. The first indication information indicates one or more sensing measurement modes supported by an STA.

The one or more sensing measurement modes supported by the STA may also be regarded as basic capability information of the STA supporting a sensing measurement.

The STA has not established an initial association link (i.e., an initial link setup) with the AP for communications.

The one or more sensing measurement modes supported by the STA include at least one of the following: a TB measurement, an R2R measurement, a Non-TB measurement, or an SBP measurement. As an example, the AP may receive the first message frame transmitted by the STA that has not established the initial association link with the AP. The first message frame includes the first indication information, and the first indication information indicates the one or more sensing measurement modes supported by the STA.

In the communication method applied to the AP provided in the present disclosure, the one or more sensing measurement modes supported by the STA that has not established the initial association link with the AP include at least one of: the TB measurement or the R2R measurement.

The R2R measurement means that the AP triggers an entire sensing measurement procedure, one STA serves as a transmitter (i.e., a sensing transmitter) of an NDP frame, and the other STAs serve as receivers (i.e., sensing receivers) of the NDP frame, and perform the sensing measurement after receiving the NDP frame. Meanwhile, when the STA serves as the transmitter of the NDP frame, the AP may also receive the NDP frame and perform the sensing measurement.

As an example, the AP may receive the first message frame transmitted by the STA that has not established the initial association link with the AP. The first message frame indicates, via the first indication information, that the STA supports at least one of: the TB measurement or the R2R measurement.

In the communication method applied to the AP provided in the present disclosure, the first message frame transmitted by the STA that has not established the initial association link with the AP is at least one of: a sensing measurement setup request frame, a sensing measurement setup query frame, or a sensing measurement setup notification frame.

In a possible implementation, the AP receives the one or more sensing measurement modes supported and transmitted by the STA before receiving the sensing measurement setup request frame. The one or more sensing measurement modes supported by the STA include at least one of the following: the TB measurement, the R2R measurement, the Non-TB measurement, or the SBP measurement. That is, the STA may transmit the one or more sensing measurement modes supported by the STA before transmitting the sensing measurement setup request frame.

In another possible implementation, the AP may determine the one or more sensing measurement modes supported by the STA via the sensing measurement setup request frame transmitted by the STA. The one or more sensing measurement modes supported by the STA include at least one of the following: the TB measurement, the R2R measurement, the Non-TB measurement, or the SBP measurement. That is, the STA may indicate other sensing measurement modes supported by the STA while transmitting the sensing measurement setup request frame that may be configured to request a setup of one sensing measurement mode supported by the STA. For example, the first indication information may indicate all the sensing measurement modes supported by the STA. For example, the first indication information may indicate the other sensing measurement modes supported by the STA, and the other sensing measurement modes do not include the sensing measurement mode whose setup is required by the sensing measurement setup request frame. In an illustrative example, it is assumed that the STA supports the TB measurement, the R2R measurement, the Non-TB measurement and the SBP measurement, and the Non-TB measurement is to be established between the AP and the STA via the sensing measurement setup request frame. In this case, the sensing measurement setup request frame also includes the first indication information. The first indication information indicates all the sensing measurement modes supported by the STA (the TB measurement, the R2R measurement, the Non-TB measurement, and the SBP measurement). Alternatively, the first indication information indicates the other sensing measurement modes supported by the STA, and the other sensing measurement modes do not include the sensing measurement mode whose setup is required by the sensing measurement setup request frame (the TB measurement, the R2R measurement and the SBP measurement are included, and the Non-TB measurement is not included since the Non-TB measurement is the sensing measurement mode whose setup is required by the sensing measurement setup request frame).

In yet another possible implementation, the AP may receive the sensing measurement setup query frame or the sensing measurement setup notification frame transmitted by the STA after receiving the sensing measurement setup request frame transmitted by the STA. The sensing measurement setup query frame or the sensing measurement setup notification frame transmitted by the STA includes the first indication information. The first indication information indicates that the STA supports at least one of the following sensing measurement modes: the TB measurement, the R2R measurement, the Non-TB measurement, or the SBP measurement. For example, the first indication information may indicate all the sensing measurement modes supported by the STA. For example, the first indication information may indicate the other sensing measurement modes supported by the STA, and the other sensing measurement modes do not include the sensing measurement mode whose setup is required by the sensing measurement setup request frame. In an illustrative example, it is assumed that the STA supports the TB measurement, the R2R measurement, the Non-TB measurement and the SBP measurement, and the Non-TB measurement is to be established between the STA and the AP via the sensing measurement setup request frame. In this case, the first indication information is transmitted via the sensing measurement setup query frame or the sensing measurement setup notification frame that includes the first indication information. The first indication information indicates all the sensing measurement modes supported by the STA (the TB measurement, the R2R measurement, the Non-TB measurement, and the SBP measurement). Alternatively, the first indication information indicates the other sensing measurement modes supported by the STA. The other sensing measurement modes do not include the sensing measurement mode whose setup is required by the sensing measurement setup request frame (the TB measurement, the R2R measurement and the SBP measurement are included, and the Non-TB measurement is not included since the Non-TB measurement is the sensing measurement mode whose setup is required by the sensing measurement setup request frame).

As an example, the AP receives the sensing measurement setup request frame transmitted by the STA that has not established the initial association link with the AP. The sensing measurement setup request frame includes the first indication information, and the first indication information indicates the one or more sensing measurement modes supported by the STA.

As an example, the AP receives the sensing measurement setup query frame transmitted by the STA that has not established the initial association link with the AP. The sensing measurement setup query frame includes the first indication information, and the first indication information indicates the one or more sensing measurement modes supported by the STA.

As an example, the AP receives the sensing measurement setup notification frame transmitted by the STA that has not established the initial association link with the AP. The sensing measurement setup notification frame includes the first indication information, and the first indication information indicates the one or more sensing measurement modes supported by the STA.

In a possible implementation, the one or more sensing measurement modes supported by the STA include at least one of the following: the TB measurement, the R2R measurement, the Non-TB measurement, or the SBP measurement.

In the communication method applied to the AP provided in the present disclosure, when the first message frame is the sensing measurement setup request frame, the sensing measurement setup request frame is configured to request the setup of at least one of: the Non-TB measurement or the SBP measurement.

The sensing measurement whose setup is requested by the sensing measurement setup request frame is a sensing measurement mode supported by the AP, where the STA serves as a sensing initiator of the sensing measurement whose setup is requested, and the AP serves as a sensing responder of the sensing measurement whose setup is requested.

As an example, the AP receives the sensing measurement setup request frame transmitted by the STA that has not established the initial association link with the AP, and the sensing measurement setup request frame is configured to request the setup of at least one of: the Non-TB measurement or the SBP measurement. In one implementation, the sensing measurement setup request frame may also include the first indication information, and the first indication information indicate the one or more sensing measurement modes supported by the STA that has not established the initial association link with the AP, where the one or more sensing measurement modes may be at least one of: the TB measurement or the R2R measurement.

In the communication method applied to the AP provided in the present disclosure, when the first message frame is the sensing measurement setup query frame or the sensing measurement setup notification frame and before the first message frame is received, the method further includes: receiving the sensing measurement setup request frame.

The sensing measurement setup request frame is configured to request the setup of at least one of: the Non-TB measurement or the SBP measurement. The sensing measurement setup query frame or the sensing measurement setup notification frame includes the first indication information that indicates the one or more supported sensing measurement modes.

That is, after the sensing measurement setup request frame transmitted by the STA that has not established the initial association link with the AP is received, the sensing measurement setup query frame or the sensing measurement setup notification frame transmitted by the STA is also received. The first indication information in the sensing measurement setup query frame or the sensing measurement setup notification frame indicates the one or more sensing measurement modes supported by the STA.

The communication method applied to the AP provided in the present disclosure also includes: transmitting a second message frame. The second message frame includes second indication information, and the second indication information indicates one or more sensing measurement modes supported by the AP.

In a possible implementation, before the STA indicates the one or more sensing measurement modes supported by the STA via the first indication information, the AP may transmit the second message frame, where the second message frame indicates the one or more sensing measurement modes supported by the AP.

In another possible implementation, after the STA indicates the one or more sensing measurement modes supported by the STA via the first indication information, the AP may transmit the second message frame, where the second message frame indicates the one or more sensing measurement modes supported by the AP.

In yet another possible implementation, the AP transmits the second message frame while the STA indicates the one or more sensing measurement modes supported by the STA via the first indication information, where the second message frame indicates the one or more sensing measurement modes supported by the AP.

That is, the example of the present disclosure does not limit the slots for transmitting the first message frame and the second message frame. The first message frame and the second message frame may be transmitted in any order or at the same time, all of which are within the protection scope of the technical solutions of the present disclosure.

The one or more sensing measurement modes supported by the AP include at least one of the following: the TB measurement, the R2R measurement, the Non-TB measurement, or the SBP measurement.

As an example, the second message frame is transmitted to the STA that has not established the initial association link with the AP, where the second message frame includes the second indication information that indicates the one or more measurement modes supported by the AP. After transmitting the second message frame, the AP may receive the sensing measurement setup request frame transmitted by the STA, where the sensing measurement setup request frame is configured to request the setup of a sensing measurement mode supported by both the STA and the AP, which may be the Non-TB measurement or the SBP measurement.

In the communication method applied to the AP provided in the present disclosure, the second message frame transmitted to the STA that has not established the initial association link with the AP is at least one of: a beacon frame or a probe response frame.

As an example, the beacon frame is transmitted to the STA that has not established the initial association link with the AP, where the beacon frame includes the second indication information that indicates the one or more sensing measurement modes supported by the AP.

As an example, the probe response frame is transmitted to the STA that has not established the initial association link with the AP, where the probe response frame includes the second indication information that indicates the one or more measurement modes supported by the AP.

The communication method applied to the AP provided in the present disclosure also includes: transmitting a sensing measurement setup response frame.

The sensing measurement setup response frame includes first identifier information. The first identifier information indicates one or more sensing measurement modes in which the AP allows the STA to participate.

As an example, in a case where the first message frame is the sensing measurement setup request frame, the AP receives the sensing measurement setup request frame, which is transmitted by the STA that has not established the initial association link with the AP and is configured to request the setup of the Non-TB measurement or the SBP measurement. The sensing measurement setup request frame includes the first indication information that indicates the one or more sensing measurement modes supported by the STA. After receiving the sensing measurement setup request frame, the AP may transmit the sensing measurement setup response frame to the STA. The sensing measurement setup response frame includes the first identifier information that indicates the one or more sensing measurement modes in which the AP allows the STA to participate.

As an example, in a case where the first message frame is the sensing measurement setup query frame or the sensing measurement setup notification frame, the AP receives the sensing measurement setup request frame, which is transmitted by the STA that has not established the initial association link with the AP and is configured to request the setup of the Non-TB measurement or the SBP measurement. Further, the AP may transmit the sensing measurement setup response frame to the STA. The sensing measurement setup response frame includes the first identifier information that indicates the one or more sensing measurement modes in which the AP allows the STA to participate. Then, the AP may receive the sensing measurement setup query frame or the sensing measurement setup notification frame transmitted by the STA. The sensing measurement setup query frame or the sensing measurement setup notification frame includes the first indication information that indicates the one or more sensing measurement methods supported by the STA.

The one or more sensing measurement modes, which are indicated by the first identifier information and in which the STA is allowed to participate, include at least one of the following: the TB measurement, the R2R measurement, the Non-TB measurement, or the SBP measurement. For example, the AP may transmit the sensing measurement setup response frame to the STA. The sensing measurement setup response frame includes the first identifier information, and the first identifier information indicates that the AP allows the STA to participate in the R2R measurement or the Non-TB measurement.

In the communication method applied to the AP provided in the present disclosure, the sensing measurement setup response frame, which is transmitted to the STA that has not established the initial association link with the AP, includes at least one of: a UID or a TSF parameter assigned by the AP to the STA.

The UID is configured to identify the sensing measurement whose setup is requested by the sensing measurement setup request frame.

The TSF parameter is configured to enable the STA and the AP to maintain time synchronization during the sensing measurement procedure.

In the communication method applied to the AP provided in the present disclosure, the AP receives the sensing measurement setup request frame after performing a PASN with the STA that has not established the initial association link with the AP. That is, the AP receives the sensing measurement setup request frame from the STA after performing the PASN with the STA, so as to ensure a data transmission security.

In the communication method applied to the AP provided in the present disclosure, the sensing measurement setup request frame, which is transmitted by the STA that has not established the initial association link with the AP, includes a sensing measurement setup identifier for identifying the sensing measurement setup procedure.

In the communication method applied to the AP provided in the present disclosure, after receiving the first message frame, the AP may initiate a new sensing measurement setup procedure according to the one or more sensing measurement modes supported by the STA that has not established the initial association link with the AP. The new sensing measurement setup procedure is configured to establish a sensing measurement mode supported by both the STA and the AP, such as the TB measurement or the R2R measurement.

The communication methods provided in the present disclosure are further described below with reference to some examples.

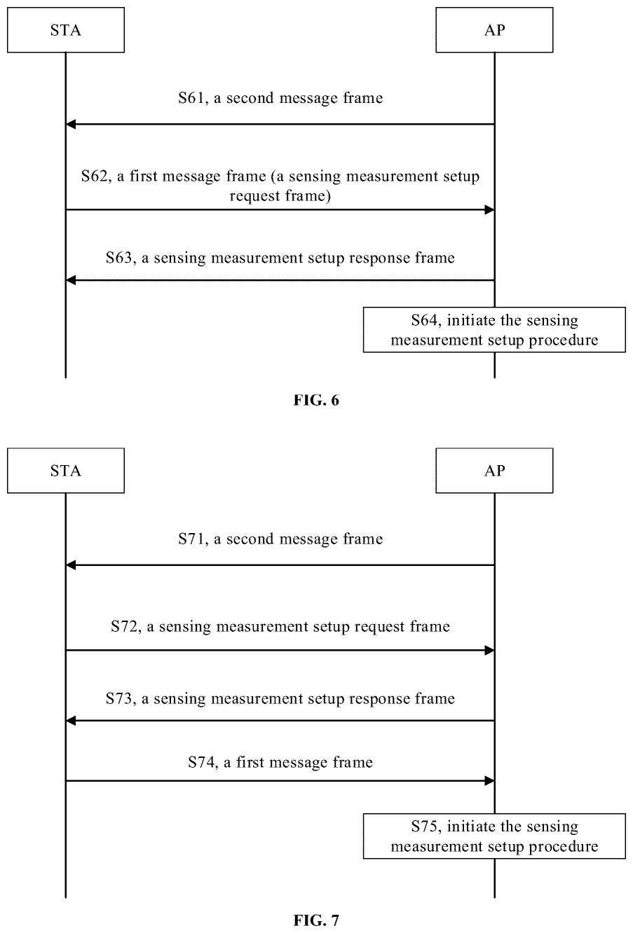

Referring to FIG. 6, FIG. 6 is a schematic timing diagram of the communication methods provided in an example of the present disclosure. The communication method illustrated in FIG. 6 may include the following steps.

At step S61, an AP transmits a second message frame to an STA that has not established an initial association link with the AP.

The second message frame includes second indication information. The second indication information indicates one or more sensing measurement modes supported by the AP.

The one or more sensing measurement modes supported by the AP include at least one of the following: a TB measurement, an R2R measurement, the Non-TB measurement, or an SBP measurement.

The second message frame may be a beacon frame or a probe response frame.

At step S62, the STA transmits a first message frame to the AP.

The first message frame may be a sensing measurement setup request frame.

The sensing measurement setup request frame is configured to request a setup of at least one of: the Non-TB measurement or the SBP measurement.

The first message frame includes first indication information. The first indication information indicates one or more sensing measurement modes supported by the STA. The one or more sensing measurement modes supported by the STA include at least one of the following: the TB measurement, the R2R measurement, the Non-TB measurement, or the SBP measurement.

The first message frame includes a sensing measurement setup identifier, which is configured to identify a sensing measurement setup procedure corresponding to the sensing measurement setup request frame.

The STA transmits the first message frame after performing a PASN with the AP.

At step S63, the AP transmits a sensing measurement setup response frame to the STA.

The sensing measurement setup response frame includes at least one of: a UID or a TSF parameter assigned by the AP to the STA. The UID is configured to identify the sensing measurement whose setup is requested by the sensing measurement setup request frame. The TSF parameter is configured to enable the STA and the AP to maintain time synchronization during the sensing measurement procedure.

The sensing measurement setup response frame includes first identifier information. The first identifier information indicates one or more sensing measurement modes in which the AP allows the STA to participate. For example, the sensing measurement modes in which the AP allows the STA to participate may be the R2R measurement or the Non-TB measurement.

At step S64, the AP initiates the sensing measurement setup procedure.

For the sensing measurement mode corresponding to the sensing measurement setup procedure initiated by the AP, the AP allows the STA to participate in the sensing measurement mode and the STA supports the sensing measurement mode.

Referring to FIG. 7, FIG. 7 is another timing diagram of the communication methods provided in the present disclosure. The communication method illustrated in FIG. 7 may include the following steps.

At step S71, an AP transmits a second message frame to an STA that has not established an initial association link with the AP.

The second message frame includes second indication information. The second indication information indicates one or more sensing measurement modes supported by the AP.

The one or more sensing measurement modes supported by the AP include at least one of the following: a TB measurement, an R2R measurement, a Non-TB measurement, or an SBP measurement.

The second message frame may be a beacon frame or a probe response frame.

At step S72, the STA transmits a sensing measurement setup request frame to the AP.

The sensing measurement setup request frame is configured to request a setup of at least one of: the Non-TB measurement or the SBP measurement.

The sensing measurement setup request frame includes a sensing measurement setup identifier, which is configured to identify a sensing measurement setup procedure corresponding to the sensing measurement setup request frame.

The STA transmits the sensing measurement setup request frame after performing a PASN with the AP.

At step S73, the AP transmits a sensing measurement setup response frame to the STA.

The sensing measurement setup response frame includes at least one of: a UID or a TSF parameter assigned by the AP to the STA. The UID is configured to identify the sensing measurement whose setup is requested by the sensing measurement setup request frame. The TSF parameter is configured to enable the STA and the AP to maintain time synchronization during the sensing measurement procedure.

The sensing measurement setup response frame includes first identifier information. The first identifier information indicates one or more sensing measurement modes in which the AP allows the STA to participate. For example, the sensing measurement modes in which the AP allows the STA to participate may be the R2R measurement or the Non-TB measurement.

At step S74, the STA transmits a first message frame to the AP.

The first message frame includes first indication information. The first indication information indicates one or more sensing measurement modes supported by the STA. The one or more sensing measurement modes supported by the STA include at least one of the following: the TB measurement, the R2R measurement, the Non-TB measurement, or the SBP measurement.

The first message frame may be a sensing measurement setup query frame or a sensing measurement setup notification frame.

At step S75, the AP initiates the sensing measurement setup procedure.

For the sensing measurement mode corresponding to the sensing measurement setup procedure initiated by the AP, the AP allows the STA to participate in the sensing measurement mode and the STA supports the sensing measurement mode.

In the communication methods applied to the AP provided in the present disclosure, for the STA that has not established the initial association link with the AP for communications, it may transmit the sensing measurement setup request frame, the sensing measurement setup query frame or the sensing measurement setup notification frame to the AP, so as to indicate the one or more sensing measurement modes supported by it via the first indication information therein, thereby enabling the AP to initiate the setup procedure of the corresponding sensing measurement mode.

As illustrated in FIG. 8, an example of the present disclosure provides a communication apparatus, including a determining unit 81 and a first transceiving unit 82.

The determining unit 81 is configured to determine a first message frame. The first message frame includes first indication information, the first indication information indicates one or more sensing measurement modes supported by an STA, and the STA has not established an initial association link with an AP for communications.

The first transceiving unit 82 is configured to transmit the first message frame.

Alternatively, or additionally, in the example of the present disclosure, the one or more sensing measurement modes supported by the STA include at least one of the following: a TB measurement; or an R2R measurement.

Alternatively, or additionally, in the example of the present disclosure, the first message frame is at least one of: a sensing measurement setup request frame, a sensing measurement setup query frame, or a sensing measurement setup notification frame

Alternatively, or additionally, in the example of the present disclosure, when the first message frame is the sensing measurement setup request frame, the sensing measurement setup request frame is configured to request a setup of at least one of: a Non-TB measurement or an SBP measurement.

Alternatively, or additionally, in the example of the present disclosure, before transmitting the first message frame that is the sensing measurement setup query frame or the sensing measurement setup notification frame, the first transceiving unit 82 is further configured to: transmit a sensing measurement setup request frame. The sensing measurement setup request frame is configured to request the setup of at least one of: the Non-TB measurement or the SBP measurement.

Alternatively, or additionally, in the example of the present disclosure, before transmitting the sensing measurement setup request frame, the first transceiving unit 82 is further configured to: receive a second message frame. The second message frame includes second indication information, the second indication information indicates one or more sensing measurement modes supported by the AP, and the one or more sensing measurement modes supported by the AP include at least one of: the TB measurement, the R2R measurement, the Non-TB measurement, or the SBP measurement.

Alternatively, or additionally, in the example of the present disclosure, the second message frame is at least one of: a beacon frame or a probe response frame.

Alternatively, or additionally, in the example of the present disclosure, after transmitting the sensing measurement setup request frame, the first transceiving unit 82 is further configured to: receive a sensing measurement setup response frame. The sensing measurement setup response frame includes first identifier information, and the first identifier information indicates one or more sensing measurement modes in which the AP allows the STA to participate.

Alternatively, or additionally, in the example of the present disclosure, the sensing measurement setup response frame includes at least one of: a UID or a TSF parameter allocated by the AP to the STA.

Alternatively, or additionally, in the example of the present disclosure, the STA transmits the sensing measurement setup request frame after performing a PASN with the AP.

Alternatively, or additionally, in the example of the present disclosure, the sensing measurement setup request frame includes a sensing measurement setup identifier.

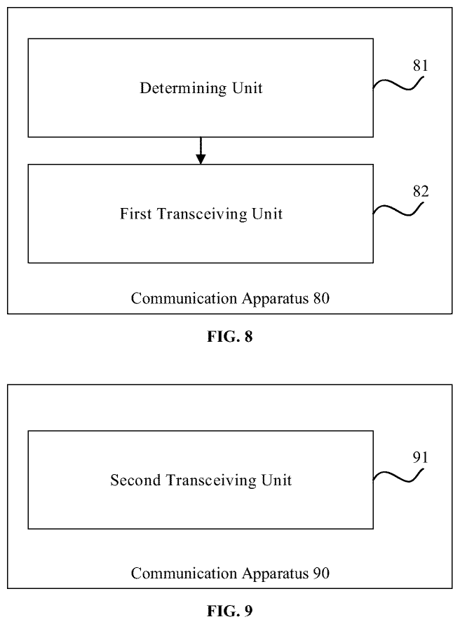

As illustrated in FIG. 9, an example of the present disclosure provides a communication apparatus, including a second transceiving unit 91.

The second transceiving unit 91 is configured to receive a first message frame. The first message frame includes first indication information, the first indication information indicates one or more sensing measurement modes supported by an STA, and the STA has not established an initial association link with an AP for communications.

Alternatively, or additionally, in the example of the present disclosure, the one or more sensing measurement modes supported by the STA include at least one of the following: a TB measurement; or an R2R measurement.

Alternatively, or additionally, in the example of the present disclosure, the first message frame is at least one of: a sensing measurement setup request frame, a sensing measurement setup query frame, or a sensing measurement setup notification frame

Alternatively, or additionally, in the example of the present disclosure, when the first message frame is the sensing measurement setup request frame, the sensing measurement setup request frame is configured to request a setup of at least one of: a Non-TB measurement or an SBP measurement.

Alternatively, or additionally, in the example of the present disclosure, before receiving the first message frame that is the sensing measurement setup query frame or the sensing measurement setup notification frame, the second transceiving unit 91 is further configured to: receive a sensing measurement setup request frame. The sensing measurement setup request frame is configured to request the setup of at least one of: the Non-TB measurement or the setup of the SBP measurement.

Alternatively, or additionally, in the example of the present disclosure, before receiving the sensing measurement setup request frame, the second transceiving unit 91 is further configured to: transmit a second message frame. The second message frame includes second indication information, the second indication information indicates one or more sensing measurement modes supported by the AP, and the one or more sensing measurement modes supported by the AP include at least one of: the TB measurement, the R2R measurement, the Non-TB measurement, or the SBP measurement.

Alternatively, or additionally, in the example of the present disclosure, the second message frame is at least one of: a beacon frame or a probe response frame.

Alternatively, or additionally, in the example of the present disclosure, after receiving the sensing measurement setup request frame, the second transceiving unit 91 is further configured to: transmit a sensing measurement setup response frame. The sensing measurement setup response frame includes first identifier information, and the first identifier information indicates one or more sensing measurement modes in which the AP allows the STA to participate.

Alternatively, or additionally, in the example of the present disclosure, the sensing measurement setup response frame includes at least one of: a UID or a TSF parameter allocated by the AP to the STA.

Alternatively, or additionally, in the example of the present disclosure, the AP receives the sensing measurement setup request frame after performing a PASN with the STA.

Alternatively, or additionally, in the example of the present disclosure, the apparatus further includes a sensing measurement establishing unit, and the sensing measurement establishing unit is configured to: initiate a setup procedure in a sensing measure mode supported by the STA.

Alternatively, or additionally, in the example of the present disclosure, the sensing measurement setup request frame includes a sensing measurement setup identifier.

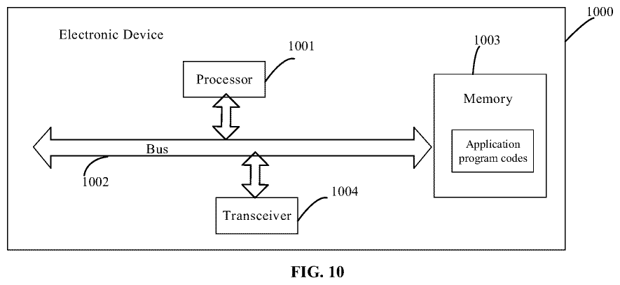

An example of the present disclosure further provides an electronic device, as illustrated in FIG. 10. The electronic device 1000 illustrated in FIG. 10 includes a processor 1001 and a memory 1003. The processor 1001 and the memory 1003 are connected, for example, via a bus 1002. Alternatively, or additionally, the electronic device 1000 may further include a transceiver 1004. It is to be noted that in actual applications, the number of transceivers 1004 is not limited to one, and the structure of the electronic device 1000 does not constitute a limitation on the examples of the present disclosure.

The memory 1003 is configured to store application program codes for executing the examples of the present disclosure, and the execution is controlled by the processor 1001. When the electronic device 1000 acts as an STA, the processor 1001 is configured to execute the application program codes stored in the memory 1003 to implement the communication methods applicable to the STA in the present solutions. When the electronic device 1000 acts as an AP, the processor 1001 is configured to execute the application program codes stored in the memory 1003 to implement the communication methods applicable to the AP in the present solutions.

The bus 1002 may include a channel for transmitting information between the above components. The bus 1002 may be a peripheral component interconnect (PCI) bus or an extended industry standard architecture (EISA) bus, etc. The bus 1002 may be divided into an address bus, a data bus, a control bus, and so on. For ease of representation, only a thick line is illustrated in FIG. 10, but it does not mean that there is only one bus or one type of bus.

The memory 1003 may be a read-only memory (ROM) or other types of static storage devices that can store static information and instructions, a random access memory (RAM) or other types of dynamic storage devices that can store information and instructions, or an electrically erasable programmable read-only memory (EEPROM), a compact disc read-only memory (CD-ROM) or other optical disk storage, an optical disc storage (including a compressed optical disc, a laser disc, an optical disc, a digital versatile disc, a Blu-ray disc, etc.), a magnetic disk storage medium or other magnetic storage devices, or any other medium that can be configured to carry or store the desired program codes in the form of instructions or data structures and can be accessed by a computer, but is not limited to these.

An example of the present disclosure provides a computer-readable storage medium, on which a computer program is stored. The computer program, when running on a computer, enables the computer to perform the corresponding contents of the foregoing method examples.

Although the steps in the flowcharts of the accompanying drawings are displayed sequentially as indicated by the arrows, it is to be understood that these steps are not necessarily performed sequentially in the order indicated by the arrows. Unless otherwise specified herein, there is no strict order limitation for performing these steps and these steps may be performed in other orders. In addition, at least part of the steps in the flowcharts of the accompanying drawings may include multiple sub-steps or multiple phases. These sub-steps or phases are not necessarily performed at the same time, but may be performed at different moments. The order of these sub-steps or phases is not necessarily sequential, but may rotate or alternate with at least part of another step or sub-steps or phases thereof.

It is to be noted that the computer-readable storage medium in the present disclosure may be a computer-readable signal medium, a computer-readable storage medium or any combination of the two. The computer readable storage medium may be, for example but not limited to, an electronic, magnetic, optical, electromagnetic, infrared, or semiconductor system, apparatus, or component, or any combination thereof. More specific examples of the computer-readable storage medium may include, but are not limited to, an electrical connection having one or more conductors, a portable computer disk, a hard disk, an RAM, an ROM, an EPROM or a flash memory, an optical fiber, a portable compact disk-read-only memory (CD-ROM), an optical storage device, a magnetic storage device, or any suitable combination thereof. In the present disclosure, the computer-readable storage medium may be any tangible medium that contains or stores a program that may be use by or in connection with an instruction execution system, apparatus, or device. In the present disclosure, a computer-readable signal medium may include data signals propagated in a baseband or as a part of a carrier wave, in which computer-readable program codes are carried. Such the propagated data signals may take a variety of forms, including but not limited to electromagnetic signals, optical signals, or any suitable combination thereof. The computer-readable signal medium may also be any computer-readable medium other than the computer-readable storage medium. The computer-readable signal medium may send, propagate, or transport the program that is use by or in connection with the instruction execution system, apparatus, or device. The program codes contained on the computer-readable storage medium may be transmitted via any appropriate medium, including but not limited to: a wire, an optical cable, radio frequency (RF), etc., or any suitable combination thereof.

The computer-readable storage medium may be included in the STA or the AP; or may exist independently without being installed in the STA or the AP.

The computer-readable storage medium carries one or more programs. When the one or more programs are executed by the STA or the AP, the STA or the AP performs the corresponding communication methods.

According to one aspect of the present disclosure, a computer program product or a computer program is provided. The computer program product or the computer program includes computer instructions stored in a computer-readable storage medium. One or more processors of the computer device read the computer instructions from the computer-readable storage medium and execute the computer instructions, so that the computer device performs the communication methods provided in the various candidate implementations.

Computer program codes for performing operations of the present disclosure may be written in one or more programming languages, or a combination thereof, including object-oriented programming languages such as Java, Smalltalk, C++, and conventional procedural programming languages such as “C” or similar programming languages. The program codes may be executed entirely on a user computer, partly on the user computer, as a stand-alone software package, partly on the user computer and partly on a remote computer, or entirely on the remote computer or server. In a case involving a remote computer, the remote computer may be connected to the user computer through any type of network, including a local area network (LAN) or a wide area network (WAN), or may be connected to an external computer, for example, through the Internet by an Internet service provider.

The flowcharts and block diagrams in the accompanying drawings illustrate possible implementation architectures, functions, and operations of the systems, the methods, and the computer program products according to various examples of the present disclosure. In this regard, each block in the flowchart or block diagram may represent a module, a program segment or a portion of codes, which contains one or more executable instructions for implementing the specified logical functions. It is also to be noted that, in some alternative implementations, the functions pointed by the blocks may occur out of the order pointed by the accompanying drawings. For example, two blocks shown in succession may actually be executed substantially in parallel, or may sometimes be executed in a reverse order, depending on the involved functions. It is also to be noted that each block in the block diagram and/or flowchart, and a combinations of blocks in the block diagram and/or flowchart, may be implemented by a dedicated hardware-based system that performs a specified function or operation, or may be implemented by a combination of dedicated hardware and computer instructions.

The modules involved in the described examples of the present disclosure may be implemented by software or by hardware. The name of a module does not, in some cases, constitute a limitation on the module itself. For example, module A may also be described as “module A for performing operation B”.

The above description is only an illustration of the preferred examples of the present disclosure and the technical principles used in the present disclosure. Those skilled in the art should understand that the scope of disclosure involved in the present disclosure is not limited to the technical solutions formed by specific combinations of the above technical features, but should also cover other technical solutions formed by any combination of the above technical features or their equivalent features without departing from the disclosure concepts, for example, the technical solutions formed by replacing the above features with, but not limited to, the technical features having similar functions disclosed in the present disclosure.

1. A method for wireless communication, performed by a station (STA), the method comprising:
determining a first message frame, wherein the first message frame comprises first indication information, the first indication information indicates one or more sensing measurement modes supported by the STA, and the STA has not established an initial association link with an access point (AP) for communications; and
transmitting the first message frame.

2. The method according to claim 1, wherein the one or more sensing measurement modes supported by the STA comprise at least one of:
a trigger-based (TB) measurement; or
a responder-to-responder (R2R) measurement.

3. The method according to claim 1, wherein the first message frame is one of: a sensing measurement setup request frame, a sensing measurement setup query frame, or a sensing measurement setup notification frame.

4. The method according to claim 3,
wherein in a case that the first message frame is the sensing measurement setup request frame, the sensing measurement setup request frame is configured to request a setup of at least one of: a non-trigger-based (Non-TB) measurement or a sensing before proxy (SBP) measurement.

5. The method according to claim 3, wherein in a case that the first message frame that is the sensing measurement setup query frame or the sensing measurement setup notification frame, before transmitting the first message frame, the method further comprises:
transmitting the sensing measurement setup request frame, wherein the sensing measurement setup request frame is configured to request a setup of at least one of: a non-trigger-based (Non-TB) measurement or a sensing before proxy (SBP) measurement.

6. The method according to claim 1, further comprising:
receiving a second message frame,
wherein the second message frame comprises second indication information, the second indication information indicates one or more sensing measurement modes supported by the AP, and the one or more sensing measurement modes supported by the AP comprise at least one of: a trigger-based (TB) measurement, a responder-to-responder (R2R) measurement, a non-trigger-based (Non-TB) measurement, or a sensing before proxy (SBP) measurement.

7. (canceled)

8. The method according to claim 4, wherein after transmitting the sensing measurement setup request frame, the method further comprises:
receiving a sensing measurement setup response frame, wherein the sensing measurement setup response frame comprises first identifier information, and the first identifier information indicates one or more sensing measurement modes in which the AP allows the STA to participate.

9. The method according to claim 8, wherein the sensing measurement setup response frame comprises at least one of: an un-association identifier (UID) or a time synchronization function (TSF) parameter allocated by the AP to the STA.

10. The method according to claim 4, wherein the STA transmits the sensing measurement setup request frame after performing a pre-association security negotiation (PASN) with the AP.

11. (canceled)

12. A method for wireless communication, performed by an access point (AP), the method comprising:
receiving a first message frame, wherein the first message frame comprises first indication information, the first indication information indicates one or more sensing measurement modes supported by a station (STA), and the STA has not established an initial association link with the AP for communications.

13. The method according to claim 12, wherein the one or more sensing measurement modes supported by the STA comprise at least one of:
a trigger-based (TB) measurement; or
a responder-to-responder (R2R) measurement.

14. The method according to claim 12, wherein the first message frame is one of: a sensing measurement setup request frame, a sensing measurement setup query frame, or a sensing measurement setup notification frame.

15. The method according to claim 14,
wherein in a case that the first message frame is the sensing measurement setup request frame, the sensing measurement setup request frame is configured to request a setup of at least one of: a non-trigger-based (Non-TB) measurement or a sensing before proxy (SBP) measurement.

16. The method according to claim 14, wherein in a case that the first message frame that is the sensing measurement setup query frame or the sensing measurement setup notification frame, before receiving the first message frame, the method further comprises:
receiving the sensing measurement setup request frame, wherein the sensing measurement setup request frame is configured to request a setup of at least one of: a non-trigger-based (Non-TB) measurement or a sensing before proxy (SBP) measurement.

17. The method according to claim 12, further comprising:
transmitting a second message frame, wherein the second message frame comprises second indication information, the second indication information indicates one or more sensing measurement modes supported by the AP, and the one or more sensing measurement modes supported by the AP comprise at least one of: a trigger-based (TB) measurement, a responder-to-responder (R2R) measurement, a non-trigger-based (Non-TB) measurement, or a sensing before proxy (SBP) measurement.

18. (canceled)

19. The method according to claim 15, wherein after receiving the sensing measurement setup request frame, the method further comprises:
transmitting a sensing measurement setup response frame, wherein the sensing measurement setup response frame comprises first identifier information, and the first identifier information indicates one or more sensing measurement modes in which the AP allows the STA to participate.

20. The method according to claim 19, wherein the sensing measurement setup response frame comprises at least one of: an un-association identifier (UID) or a time synchronization function (TSF) parameter allocated by the AP to the STA.

21. The method according to claim 15, wherein the AP receives the sensing measurement setup request frame after performing a pre-association security negotiation (PASN) with the STA.

22.-25. (canceled)

26. A station (STA), comprising:
one or more memories,
one or more processors, and
a computer program stored in the one or more memories and executable on the one or more processors;
wherein the computer program, when collectively executed by the one or more processors, causes the STA to:
determine a first message frame, wherein the first message frame comprises first indication information, the first indication information indicates one or more sensing measurement modes supported by the STA, and the STA has not established an initial association link with an access point (AP) for communications; and
transmit the first message frame.

27. A wireless communication device comprising:
one or more memories,
one or more processors, and
a computer program stored in the one or more memories and executable on the one or more processors;
wherein the computer program, when collectively executed by the one or more processors, causes the wireless communication device to act as an access point (AP) and perform the method according to claim 12.

28. (canceled)
